(19) United States
(12) Patent Application Publication
(10) Pub. No.: US 2012/0009320 A1
(43) Pub. Date: Jan. 12, 2012

(54) COMPOSITIONS COMPRISING MONATIN AND CALCIUM

(76) Inventors: Jeffrey C. Evans, St. Michael, MN (US); Melanie Jean Goulson, Dayton, MN (US); Michael George Lindley, Berkshire (GB)

(21) Appl. No.: 13/255,565

(22) PCT Filed: Mar. 11, 2010
(86) PCT No.: PCT/US2010/026912

§ 371 Date: Sep. 9, 2011

Related U.S. Application Data
(60) Provisional application No. 61/209,926, filed on Mar. 12, 2009.

(51) Int. Cl. A23L 1/236

(52) U.S. Cl. 426/548

(57) ABSTRACT

Calcium-containing monatin compositions exhibit an enhanced sweetnessas compared to comparable compositions containing monatin in the absence of calcium. Due to the enhanced sweetness from monatin in combination with calcium, less monatin is required to achieve a particular sweetness level than would be needed in the absence of calcium. The calcium-containing monatin compositions include food products and beverages.

### CROSS REFERENCE TO RELATED APPLICATION

This application claims the benefit of the U.S. Provisional Patent Application Ser. No. 61/209,926, filed 12 Mar. 2009, entitled COMPOSITIONS COMPRISING MONATIN AND CALCIUM, which is hereby incorporated by reference in its entirety.

### TECHNICAL FIELD

This disclosure relates to compositions containing high intensity sweeteners. In particular, the disclosure relates to compositions containing monatin and calcium.

### BACKGROUND

Monatin (2-hydroxy-2-(indol-3-ylmethyl)-4-aminoglutaric acid) is a naturally occurring, high intensity or high potency sweetener that was originally isolated from the plant Sclerochiton ilicifolius, found in the Transvaal Region of South Africa. Monatin has the chemical structure:

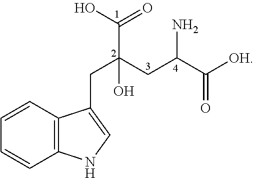

Because of various naming conventions, monatin is also known by a number of alternative chemical names, including: 2-hydroxy-2-(indol-3-ylmethyl)-4-aminoglutaric acid; 4-amino-2-hydroxy-2-(1H-indol-3-ylmethyl)-pentanedioic acid; 4-hydroxy-4-(3-indolylmethyl)glutamic acid; and, 3-(1-amino-1,3-dicarboxy-3-hydroxy-but-4-yl)indole.

Monatin has two chiral centers thus leading to four potential stereoisomeric configurations; the R,R configuration (the “R,R stereoisomer” or “R,R monatin”); the S,S configuration (the “S,S stereoisomer” or “S,S monatin”); the R,S configuration (the “R,S stereoisomer” or “R,S monatin”); and the S,R configuration (the “S,R stereoisomer” or “S,R monatin”).

Reference is made to WO 2003/091396 A2, which discloses, inter alia, polypeptides, pathways, and microorganisms for in vivo and in vitro production of monatin. WO 2003/091396 A2 (see, e.g., FIGS. 1-3 and 11-13) and U.S. Patent Publication No. 2005/282260 describe the production of monatin from tryptophan through multi-step pathways involving biological conversions with polypeptides (proteins) or enzymes. One pathway described involves converting tryptophan to indole-3-pyruvate (“I-3-P”) (reaction (1)), converting indole-3-pyruvate to 2-hydroxy 2-(indol-3-ylmethyl)-4-keto glutaric acid (monatin precursor, “MP”) (reaction (2)), and converting MP to monatin (reaction (3)), biologically, for example, with enzymes.

### SUMMARY

Provided herein are compositions containing monatin and calcium in which the perceived sweetness of the compositions is enhanced compared to compositions having the same amount of monatin and lacking calcium, and methods of making compositions containing monatin and calcium in which the perceived sweetness of the compositions is enhanced compared to compositions having the same amount of monatin and lacking calcium. The compositions include, without limitation, compositions having extrinsic calcium (i.e. calcium is added to a composition having essentially no intrinsic calcium), calcium-fortified food and beverage compositions in which additional calcium is added to a composition containing intrinsic calcium, food and beverage compositions in which calcium is intrinsic to the food or beverage, and a tabletop sweetener composition. Non-limiting examples of compositions having intrinsic calcium include without limitation dairy compositions such as ice cream, chocolate milk, pudding, cream cheese, and yogurt. Calcium-fortified food and beverage compositions include without limitation any of the foregoing compositions having intrinsic calcium in which extrinsic calcium is further added to the compositions, calcium-fortified beverages, calcium-fortified foods, calcium-fortified drink powder mixes, calcium-fortified nutrition bars, popsicles with added calcium, breakfast cereal, sugar-free and reduced sugar candy and chews, sugar-free and reduced sugar jam, jelly, fruit products, and fruit preparations gelled with calcium and low methoxy pectin, and meal replacement beverages. Calcium-fortified food and beverage compositions may also include compositions having essentially only extrinsic calcium.

In one embodiment, a non-dairy food product comprises monatin or a salt thereof, and calcium, wherein the food product has a sweetness greater than a sweetness of a comparable food product comprising monatin without calcium.

In another embodiment, a non-dairy food product comprises monatin or a salt thereof, and a calcium salt, wherein the food product has a perceived sweetness at least about 10 percent greater than a perceived sweetness of a comparable food product containing monatin in an absence of calcium.

In another embodiment, a food product comprises monatin or a salt form thereof, and extrinsic calcium, wherein the food product has a perceived sweetness greater than a perceived sweetness of a comparable food product not containing extrinsic calcium.

In another embodiment, a sweetening composition for use in a food product comprises monatin or a salt thereof, and calcium, such that the food product has a perceived sweetness greater than a perceived sweetness of a comparable food product having a sweetening composition containing a comparable amount of monatin without calcium.

In another embodiment, a method of sweetening a non-dairy food product includings adding monatin or a salt thereof to the food product and adding calcium to the food product. The food product has a perceived sweetness that is greater than a perceived sweetness of a comparable food product containing monatin without calcium.

In another embodiment, a method of sweetening a food product includes adding monatin or a salt thereof to the food product and adding a calcium salt to the food product, wherein the calcium salt is sufficiently soluble in the food product. The food product has a perceived sweetness greater than a comparable food product in which monatin, but not calcium, is added.

In another embodiment, a food product includes intrinsic calcium, and monatin or a salt form thereof, wherein the monatin is in an amount sufficient such that the food product has a sucrose equivalency value (SEV) of at least about 10%.

In some aspects, the calcium is a calcium salt, which may include calcium lactate, calcium gluconate, calcium chloride, and combinations thereof. In some aspects, an amount of calcium in the food product is at least about 25 ppm of the food product. In other aspects, an amount of calcium in the food product is at least about 200 ppm of the food product.

In some aspects, the monatin in the food products and sweetening compositions is R,R monatin. In some aspects, an amount of monatin in the food product is between about 5 and about 50 ppm of the food product.

The present disclosure relates to compositions containing monatin and calcium, which exhibit an enhanced sweetness as compared to comparable compositions containing monatin without calcium. The details of one or more non-limiting embodiments of the invention are set forth in the description below. Other embodiments of the invention should be apparent to those of ordinary skill in the art after consideration of the present disclosure.

### DETAILED DESCRIPTION

As stated above, monatin has two chiral centers leading to four potential stereoisomeric configurations. As used herein, unless otherwise indicated, the term “monatin” is used to refer to compositions including any combination of the four stereoisomers of monatin (or any of the salts thereof), including a single isomeric form.

Unless otherwise stated, the term “monatin” includes any salt thereof. As used herein, unless otherwise stated, the term “monatin” is independent of the method by which the monatin was made, and thus encompasses monatin that was, for example, synthesized in whole or in part by biosynthetic pathway(s), purely synthetic means, or isolated from a natural source. Due to various numbering systems for monatin, monatin is known by a number of alternative chemical names, including: 2-hydroxy-2-(indol-3-ylmethyl)-4-aminoglutaric acid; 4-amino-2-hydroxy-2-(1H-indol-3-ylmethyl)-pentanedioic acid; 4-hydroxy-4-(3-indolylmethyl)glutamic acid; and, 3-(1-amino-1,3-dicarboxy-3-hydroxy-but-4-yl) indole.

As used herein, “sucrose equivalency value”, or SEV, is a measure of sweetness. The SEV is the concentration (% w/v) of a sucrose solution that gives a degree of sweetness that is perceived to be the same degree of sweetness as that of a test sample. For purposes of this disclosure, the SEV of an aqueous or dairy solution containing monatin is determined through comparison of the monatin-containing solution to a series of sucrose containing solutions prepared in the same medium (see Example 1). For a non-aqueous or essentially solid food product, the SEV is the concentration of sucrose (% w/w) in a comparable food product without monatin that gives a degree of sweetness that is perceived to be the same degree of sweetness as that of the food product containing monatin.

Monatin-containing compositions are described herein as being “X” times as sweet as sucrose. The various stereoisomers of monatin are also described as being “X” times sweeter than sucrose. These values are determined from the SEV of the compositions.

As used herein, the term “about” encompasses the range of experimental error that occurs in any measurement.

As used herein, an “enhanced sweetness” of a calcium-containing monatin composition refers to a greater perceived sweetness of the composition, as compared to a perceived sweetness of a comparable composition containing monatin without calcium. It is generally accepted that calcium is not sweet. In fact, calcium is often considered to have somewhat of a bitter taste. However, as described and shown herein, when monatin is used in a composition in combination with calcium, the perceived sweetness of the composition is enhanced in the presence of calcium, as described in further detail below. As used herein, “enhanced” means that the perceived sweetness of a calcium-containing monatin composition is greater than a perceived sweetness of a comparable composition having monatin in an absence of calcium.

As used herein, a “perceived sweetness” of a composition or food product is a sweetness perceived by a person from tasting a food product or a solution. As described herein, the perceived sweetness of the disclosed examples was determined by a sensory taste panel. A food product or solution is perceived as sweet if it interacts and stimulates the receptors for sweetness on the surface of taste cells within the taste buds. The stimulated taste cells respond by releasing neurotransmitters which signal the brain to recognize a food product or solution as sweet.

As used herein, “intrinsic calcium” refers to the calcium that occurs naturally in a food product or substance. Non-limiting examples of food products and substances containing intrinsic calcium include dairy products, such as, milk, ice cream, and yogurt.

As used herein, “extrinsic calcium” refers to calcium which is added to a food product or substance. Extrinsic calcium may be added to a food product or substance that contains no calcium as well as to a food product or substance that contains intrinsic calcium. Products containing extrinsic calcium are also referred to herein as being calcium-fortified.

A “comparable food product” is used herein to compare a monatin-containing food product to essentially the same food product, but without monatin. Essentially the same food product means that the food product has essentially the same attributes, properties and/or composition as the food product it is being compared to. One skilled in the art will recognize that substitution of a conventional sweetener with a high intensity sweetener (i.e. monatin) may require inclusion of bulking agents to restore the physical and sensory properties of the food. In some cases, a “comparable food product” or a “comparable composition” is used herein to compare a calcium-containing monatin composition or food product to essentially the same monatin composition or food product, but without calcium.

As used herein, “food product”, “foodstuff”, and “food composition” include beverages.

Monatin has an excellent sweetness quality, and depending on a particular composition, monatin may be several hundred times sweeter than sucrose, and in some cases thousands of times sweeter than sucrose. As stated above, monatin has four stereoisomeric configurations. The S,S stereoisomer of monatin is about 50-200 times sweeter than sucrose by weight. The R,R stereoisomer of monatin is about 2000-2400 times sweeter than sucrose by weight.

In researching the use of monatin in food and beverage systems, the inventors unexpectedly observed a higher than expected sweetness when monatin was used in certain food and/or beverage systems. It was noted that the higher perceived sweetness was observed in food and beverages containing intrinsic calcium. For example, it was observed that when monatin was added to a beverage containing milk, the beverage had a higher level of sweetness than expected. In other words, based on the amount of monatin added to the beverage, the perceived sweetness of the beverage was enhanced or greater than expected.

It was unexpected that calcium would be the cause of the enhanced sweetness, since calcium is generally known to not be sweet, and in some cases, has a bitter taste. Moreover, in research conducted on other sweeteners, such as aspartame and sucrose, it was shown that the addition of calcium ions did not have an effect on the sweetness intensity of the sweeteners. (See Schiffman, Susan, S., Effect of temperature, pH, and ions on sweet taste, Physiology & Behavior 68 (2000), pp. 469-481.) As such, it was unexpected that a composition containing monatin and calcium would have an enhanced sweetness over a comparable composition containing monatin without calcium.

As disclosed below, experiments were conducted to determine whether it was, in fact, calcium that enhanced the perceived sweetness of monatin. These experiments analyzed various components present in milk (for example, lactose, milk fat, milk protein, and calcium) and conditions (for example, pH) to evaluate the impact of those components and conditions on the perceived sweetness of the monatin-containing compositions. The results illustrated that calcium enhanced the perceived sweetness of the monatin-containing compositions.

Provided herein are compositions containing monatin and calcium in which the perceived sweetness of the compositions is enhanced compared to compositions having the same amount of monatin and lacking calcium. Also provided herein are methods of making compositions containing monatin and calcium in which the perceived sweetness of the compositions is enhanced compared to compositions having the same amount of monatin and lacking calcium. The compositions include, without limitation, calcium-fortified food and beverage compositions, food and beverage compositions in which calcium is intrinsic to the food or beverage, and a tabletop sweetener composition. Non-limiting examples of compositions having intrinsic calcium include without limitation dairy compositions such as ice cream, flavored milk, pudding, soft cheese, and yogurt. Calcium-fortified food and beverage compositions include without limitation any of the foregoing compositions having intrinsic calcium in which extrinsic calcium is further added to the compositions, calcium-fortified beverages, calcium-fortified foods, calcium-fortified drink powder mixes, calcium-fortified nutrition bars, popsicles with added calcium, calcium-fortified breakfast cereal, sugar-free candy and chews, no sugar added jam, jelly, fruit products, and fruit preparations gelled with calcium and low methoxy pectin, and calcium-fortified meal replacement beverages.

Compositions having a predetermined sweetness and comprising monatin and calcium are provided. In some embodiments, the amount of monatin, in such compositions, is no greater than that which is necessary to achieve the predetermined sweetness and is less than that which would be needed in the absence of calcium. The enhanced sweetness of monatin in the presence of calcium can have one or more benefits. For example, a composition may use less monatin to achieve a desired sweetness, thus providing an economic benefit, or a sweetened composition may be supplemented with additional calcium to provide a composition with greater sweetness and/or a nutritional benefit (calcium fortification).

The compositions provided herein can utilize intrinsic and/or extrinsic calcium to increase the perceived sweetness of monatin. The term “calcium” refers to one or more of a calcium (II) cation, calcium salt complex, or mixture thereof. In some embodiments, calcium can be in the form of a calcium salt. Examples of calcium salts include, but are not limited to, calcium acetate, calcium aspartate, calcium glutamate, calcium arginate, calcium chloride, calcium gluconate, calcium hydroxide, calcium lactate, calcium malate, calcium nitrate, calcium nitrite, calcium oxide, calcium propionate, calcium sorbate, and calcium sulfate. It is recognized that different calcium salts may be used depending on the application. In some embodiments, calcium can be calcium chloride, calcium lactate or calcium gluconate. In some embodiments, calcium can be in the form of a commercially available soluble calcium salt, e.g., Gluconal CAL®. In some embodiments, a mixture of calcium sources is present in the composition.

As shown in the Examples section below, the type of calcium salt may impact the extent of sweetness enhancement of the monatin-containing composition. For example, as shown in the examples below, the perceived sweetness of a monatin-containing composition is enhanced most by calcium chloride as compared to other calcium salts. Accordingly, in some embodiments, the amount of monatin needed to achieve a particular predetermined sweetness may vary due to the type of calcium salt used. In some embodiments, it may be preferred to select a calcium salt or salts having a sufficient solubility in water such that at least a majority of the calcium is able to dissolve in the composition. In some embodiments, the calcium salt may preferably be a salt in which the anion (conjugate base) does not have a strong taste that may contribute an off-flavor to the composition.

In some embodiments, the calcium-containing monatin composition may contain intrinsic calcium. For example, a composition having intrinsic calcium may include, but is not limited to, a dairy composition that is derived from mammals. In some embodiments, it can be desirable to fortify a composition having intrinsic calcium with extrinsic calcium. In some embodiments, a composition contains only extrinsic calcium.

In some embodiments, an amount of calcium in the compositions described herein can be at least 25 ppm (e.g., at least 50 ppm, at least 100 ppm, and at least 150 ppm). In other embodiments, the amount of calcium may be at least 200 ppm (e.g., at least 400 ppm, at least 500 ppm, at least 600 ppm, at least 700 ppm, at least 750 ppm, at least 800 ppm, at least 900 ppm, at least 1000 ppm, at least 1200 ppm, and at least 1600 ppm calcium). In some embodiments, an amount of calcium added to the composition may depend, in part, on the type of food product and whether the food product has any intrinsic calcium. Moreover, an amount of calcium used may depend in part on an amount of monatin added to the composition. As used herein, the amount of calcium in a composition is based on the amount of calcium cations in the composition.

In some embodiments, the calcium salts are completely dissolved in the composition. In other embodiments, a portion of the calcium salt is dissolved in the composition. In some embodiments, the dissolved calcium concentrations in the composition are at least about 25 ppm. In some embodiments, the dissolved calcium concentrations are at least about 200 ppm.

As used herein, a “calcium salt” includes calcium in a dissolved form, a complex salt form, and a dissociated form. For example, it is recognized that if a calcium salt is added to a beverage, the calcium cations and corresponding anions may dissociate in the solution, and as such, the calcium is no longer in the salt form.

In some embodiments, an amount of calcium in the compositions may depend on the form of calcium. As stated above, some calcium salts cause a greater sweetness enhancement compared to other calcium salts. For example, the use of calcium chloride allows for lower amounts of calcium to be used. As shown in the examples below, when calcium chloride is used in a monatin-conatining composition, as little as 25 ppm of calcium resulted in an increase in the perceived sweetness of the monatin-containing composition. In some embodiments it may be beneficial to use less calcium in combination with monatin (i.e. a minimum amount of calcium to enhance the sweetness of monatin). For example, the use of a lower dose of a calcium salt in the composition reduces a potential for any off tastes to the composition from the calcium salt.

In some embodiments, an amount of monatin in the compositions described herein can be about 5 ppm of R,R monatin. In some embodiments, the amount of monatin in the composition is between about 5 ppm and about 50 ppm of R,R monatin. In some embodiments, the amount of monatin is between about 10 ppm and about 40 ppm of R,R monatin. As stated above, the monatin-containing compositions may comprise any mixture of the various stereoisomers of monatin. As such, the amount of monatin in the composition may depend on the stereoisomer mixture. For example, for a monatin-containing food product including a mixture of S,S monatin and R,R monatin, less R,R monatin may be used as compared to a monatin-containing food product having comparable sweetness and comprising essentially only R,R monatin.

The amounts of monatin used herein are expressed as concentrations of monatin monopotassium salt. For example, as stated above, the amount of monatin monopotassium salt used in some embodiments for the compositions described herein may range from about 10 ppm to about 40 ppm. One skilled in the art will recognize that if the amounts of monatin were expressed in the monatin acid form, then the range for the amount of monatin would be slightly lower due to the absence of the cation. For example, for a monatin monopotassium salt ranging between about 10 ppm and about 40 ppm, the monatin free acid concentration would range from about 9 ppm to about 35 ppm.

The calcium-containing monatin composition may be expressed in terms of either a molar ratio of calcium to monatin or a weight ratio of calcium to monatin. In some embodiments, a weight ratio of calcium to monatin is between about 0.5 and about 80. In some embodiments, the weight ratio of calcium to monatin is between about 2.5 and about 60. The weight ratio may depend, in part, on whether the composition contains intrinsic calcium, in which case the ratio of calcium to monatin may, in some embodiments, be higher. For compositions containing only extrinsic calcium, in some embodiments, the weight ratio of calcium to monatin is between about 2.5 and about 20.

In some embodiments, a molar ratio of calcium to monatin is between about 5 and about 700. In some embodiments, the molar ratio is between about 20 and 500. As stated above, the ratio depends in part on whether the calcium in the composition is extrinsic or intrinsic. For compositions containing only extrinsic calcium, in some embodiments, the molar ratio of calcium to monatin is between about 20 and 200.

In some embodiments, one or more additional sweeteners may be used in combination with monatin and calcium to achieve a predetermined sweetness and/or provide bulk. In some embodiments, use of monatin and calcium in combination with one or more additional sweeteners results in the use of less monatin than would be needed in the absence of calcium in the composition.

The calcium-containing monatin composition described herein can include any products, raw, prepared or processed, which are intended for human or animal consumption, including pet or wildlife consumption. In some embodiments, a composition may be provided for consumption by eating or drinking, and may optionally contain nutrients or stimulants in the form of minerals, carbohydrates (including sugars), proteins, caffeine, and/or fats.

The calcium-containing monatin composition may also be a food additive, the role of which is, at least in part, to add monatin and calcium, especially, monatin-sweetening amounts of calcium into a foodstuff or food composition.

A monatin and calcium containing composition may include any method of presenting the monatin and calcium to the taste buds. For example, the monatin can be combined with the calcium and presented to the taste buds as a homogeneous mixture, or as a non-homogeneous mixture. In some embodiments, the monatin and calcium can be in one or more separate layers, strata, or particles in the liquid or solid composition, such layers, strata, or particles being either next to each other in the composition, or separated from each other but in a manner that still permits both the monatin and calcium to be present in the mouth at the same time. In some embodiments, the calcium may be localized in a coating that covers the entirety of or a portion of, a core that contains, among other things, monatin. In some embodiments, monatin can be localized in a coating that covers the entirety of or a portion of, a core that contains, among other things, calcium. In some embodiments, the calcium and monatin may be dispersed throughout or within a composition in separate areas, or in separate forms. For a solid composition containing monatin and a calcium salt, the enhanced sweetness of the composition, due to the presence of calcium, may depend on the rate and extent that the calcium salt dissolves in the mouth before swallowing.

The monatin and calcium may be in a single composition or the monatin and calcium may be in separate compositions which may be added to the food product at the same time or at different points in time. A monatin and calcium containing composition may be in any form—i.e. a liquid, a dry blend, etc.—prior to being added to the food product. The monatin and calcium containing composition may be added to a food product at any point, for example during processing, either at the same time other raw materials are added or at an intermediate processing point. The monatin and calcium containing composition may also be added after processing by the food processor or by the consumer. As described below, in some embodiments, the monatin and calcium containing composition may be a sweetener composition that is pre-packaged or prepared as a ready to use sweetener that may be substituted for sugar.

Provided herein are food and beverage compositions that may be fortified with calcium. Non-limiting examples include calcium-fortified soft drinks (instant and ready-to-drink), fortified water and near-water beverages, frozen pops, breakfast cereals, nutrition and snack bars, and sugar-free or reduced sugar candy and confections (e.g., calcium fortified chews).

Further provided herein are fruit compositions, for example, jams, jellies, and fruit preparations and fillings containing calcium and monatin. In some embodiments, such fruit products may be gelled with calcium salts of pectin (e.g., calcium salts of low methoxy pectin).

In some embodiments, a composition, as described herein can by used to make a liquid, and especially a beverage composition, including an aqueous beverage. Such beverages include, but are not limited to, liquid dairy products, including kefir, liquid (drinkable) yogurt and flavored milk; citrus products including calcium-fortified juices, including orange juice, grape juice, including for example, the tartrate precipitate free calcium-fortified grape juice described in U.S. Pat. No. 7,033,630, and tomato juice; juices containing less than 100% juice (for example 1-50% fruit juice); instant soft drinks and flavored and/or fortified water beverages (e.g., calcium-fortified monatin-containing sports drinks and energy drinks); carbonated soft drinks; alcoholic beverages; and meal replacement beverages.

When provided as a beverage, the composition that is made by the method of the invention can be a composition that is drinkable as is (i.e., that does not need to be diluted or that is “ready to drink”) or that is a concentrate, syrup, or other formulation that can be diluted or mixed with a liquid or into a solid to form a drinkable beverage. It is recognized that a concentrate composition would have higher levels of monatin and calcium in order to achieve appropriate amounts of monatin and calcium in the diluted form of the ready to drink beverage. Also, the “beverage” composition can be a dry beverage mix that can be mixed with, for example, water, milk, or an alcoholic beverage, to form a drinkable beverage. Beverages can be fortified with calcium to achieve the enhanced sweetness of the beverage. In some embodiments, the beverages are fortified to contain at least 200 ppm of calcium.

A beverage composition can be provided as a syrup composition intended to be diluted, wherein the syrup composition comprises monatin. In some embodiments, the syrup is diluted to a final amount ranging from about 15% to about 25% by weight of the beverage that is ingested. For example, a beverage composition can be a syrup that is a concentrate adapted for dilution in a drink in a range of about 1 part syrup:3 parts diluent to about 1 part syrup:5.5 parts diluent. In some embodiments, a beverage composition can be a dry beverage mix (e.g., flavored milk powder, hot chocolate, coffee beverages, instant cappuccino, and tea). In some embodiments, a beverage composition can be a ready-to-drink composition.

Provided herein are beverage compositions made with monatin and calcium. In one example, samples with an instant tea beverage were made and included a first sample (i.e. a control) having a given amount of monatin and a second sample having the same amount of monatin in combination with calcium. The second sample had a 30% sweetness enhancement as compared to the control containing only monatin. A third sample contained 33% more monatin than the first and second samples, but no calcium. The third sample had approximately the same sweetness as the second sample, illustrating that calcium and less monatin may be used to achieve a predetermined sweetness. In another example shown below, samples were made with a berry flavored beverage to show the sweetness enhancement when calcium was used in combination with monatin. The berry flavored beverage having calcium and monatin resulted in a 9% increase in sweetness compared to the same beverage having only monatin.

In some embodiments, a composition may contain one or more dairy products, for example, compositions that contain intrinsic calcium. The amount of calcium can be provided solely by intrinsic calcium, or by a combination of intrinsic and extrinsic calcium. Such dairy compositions can be derived in whole or in part from any dairy source. Examples of dairy compositions include but are not limited to milk (including, for example, whole milk, skim milk, evaporated milk, condensed milk, dry whole milk, and dry skim milk), yogurt (including frozen yogurt), kefir, puddings, cream cheese, ice cream, sherbert, dairy desserts, dairy beverages, flavored milk (e.g., chocolate milk), lactose reduced milk, lactose free milk, dairy and non-dairy smoothies, and meal replacement beverages.

Provided herein are ice cream compositions, yogurt compositions and flavored milk compositions. In these examples, monatin was added to compositions containing intrinsic calcium and compared to a similar composition sweetened to a particular sweetness with sucrose. Samples with varying levels of monatin were then tested to determine which monatin level resulted in sweetness equivalence to the sucrose containing sample.

In some embodiments, it may be desirable for food compositions, such as, for example, ice cream or flavored milk, to have a higher sweetness level. In some embodiments, the food composition has an SEV of at least about 9%. In some embodiments, the SEV is between about 10% and about 16%. For food compositions containing intrinsic calcium, less monatin is needed to achieve the higher desired sweetness level, as compared to a comparable food composition not containing intrinsic calcium.

In some embodiments, a sweetener composition containing monatin and calcium is provided. In some embodiments, the sweetener composition is a tabletop sweetener, which includes ready-to-use sweeteners and packet formulations. In some embodiments, a given volume of the calcium-monatin sweetener composition has the same sweetness as the same volume of granulated sugar (sucrose). These compositions are ready to use sweeteners that are prepared to be used in place of granulated sugar, and therefore can be used “spoon-for-spoon” or “cup-for-cup” in place of sugar. In some embodiments, a ready-to-use sweetener comprises maltodextrin, monatin and calcium. The maltodextrin acts as a bulking agent and/or a dilutant. In some embodiments, the sweetener composition is a single serving packet formulation (usually about 1 gram to 4 grams) which can provide the predetermined sweetness of that contained in about two teaspoons of granulated sugar (sucrose) or about eight grams of granulated sugar. In some embodiments, a single serving packet of a monatin and calcium composition (e.g., 1 gram) can provide a sweetness ranging from about 0.9 to about 9.0 grams of granulated sugar (sucrose). In some embodiments, a packet formulation comprises dextrose, maltodextrin, monatin and calcium. Dextrose is a bulking agent and/or dilutant, similar to maltodextrin. Because these sweetener compositions contain monatin in combination with calcium, less monatin is used in order to achieve the same perceived sweetness of a composition containing monatin with no calcium.

The tabletop sweetener compositions disclosed herein may be added to food products, including beverages, in order to form calcium-containing monatin compositions. Disclosed herein are ranges and particular amounts of calcium and monatin, which may be used, in some embodiments, for calcium-containing monatin compositions. It is recognized that the sweetener compositions described herein have a higher concentration of monatin and calcium, as the sweetener compositions are intended to be added to a food or beverage. As disclosed in the examples below, for example, a packet formulation (about 1 gram) includes 3150 ppm or 0.315 wt % R,R monatin and 3.15 wt % calcium (in the form of calcium cations). In another example, a ready to use formulation (to be used as a direct volume substitute for sugar) includes 400 ppm of R,R monatin and 0.4 wt % calcium (in the form of calcium cations).

It is recognized that once the sweetener compositions are added to a food or beverage, the amounts of monatin and calcium in the food or beverage are lower. As stated above, the monatin disclosed herein may include any stereoisomeric mixture. Thus, the amount of monatin in the tabletop sweetener compositions may vary depending on the stereosiomers used. For example, less R,R monatin may be used in a tabletop sweetener as compared to the examples disclosed in the previous paragraph, if S,S monatin is used in combination with R,R monatin.

In some embodiments, a homogeneous tabletop sweetener composition comprising monatin and calcium is provided. A “homogeneous” tabletop sweetener composition will contain substantially the same concentration of monatin and calcium throughout the composition.

In some embodiments, the food or beverage composition may be a reduced-sugar composition. In that case, a portion of the sugar in the composition may be substituted with monatin and calcium, as compared to other compositions in which essentially all of the sugar is substituted. In reduced-sugar compositions, a lower amount of monatin, as compared to the values provided above, may be used, since some sugar is still used in the composition. For example, an ice cream composition offered as 25 percent less sugar than a regular ice cream composition may contain a reduced amount of monatin compared to the ice cream in Example 10 below.

The monatin disclosed herein may be produced using chemical synthesis, a biosynthetic pathway, or a combination thereof. In some embodiments, the composition may include a stereoisomerically-enriched monatin mixture produced in a biosynethic pathway. “Stereoisomerically-enriched monatin mixture” means that the mixture contains more than one monatin stereoisomer and at least 60% of the monatin stereoisomers in the mixture is a particular stereoisomer, such as R,R; S,S; S,R; or R,S. In other embodiments, the mixture contains greater than 65%, 70%, 75%, 80%, 85%, 90%, 95%, 98% or 99% of a particular monatin stereoisomer. In some embodiments, the monatin is stereosiomerically-enriched R,R monatin, which means that the monatin comprises at least 60% R,R monatin. In some embodiments, the monatin is R,R monatin, which means the monatin is essentially all in the form of R,R monatin.

The monatin disclosed herein may be available in a salt form, which may include, but is not limited to, a potassium salt form, a sodium salt form, and combinations thereof. Moreover, the monatin may be a calcium salt form, in which case using the calcium salt form of the monatin in a food composition results in an enhanced sweetness of the monatin-containing composition. As shown below, low levels of calcium in a calcium-containing monatin composition still results in an enhanced sweetness. Thus, the calcium salt may be used to deliver the monatin to the composition, as well as to enhance sweetness. Depending on the desired sweetness level, in some embodiments, additional calcium may be added to the calcium-containing monatin composition.

It has been further determined that certain factors can effect the extent of sweetness enhancement of the monatin, as measured by changes in the perceived sweetness of the monatin for particular compositions having monatin and calcium in combination. In some embodiments, additional compounds or physical conditions (e.g., a change in pH) can contribute to the sweetness enhancement of monatin by calcium. Alternatively, an additional compound or condition can be an antagonist to the sweetness enhancement caused by calcium and decrease the perceived sweetness of the combination, as compared to the perceived sweetness in the absence of the additional compound or under specific condition(s).

The non-limiting examples disclosed below are specific to R,R monatin; however, it is recognized that the calcium-containing monatin compositions may include any of the stereoisomeric forms of monatin, including mixtures thereof.

### EXAMPLES

### Example 1

The experiments in Example 1 were conducted to determine what components of the dairy based system may be responsible or contribute to enhancing the perceived sweetness intensity of monatin.

(i) Sample

2R,4R-Monatin mono potassium salt is used as an illustrative form of monatin for the experiments below in Example 1, as well as the other examples described herein (see Examples 2-12). In this example, as well as in Examples 2, 3, 4 (Table 4 only), Example 5, and Examples 8-10, the monatin in the samples was produced using a chemical synthesis.

(ii) Solution Compositions

Monatin compositions were prepared by adding monatin to each of the solutions below at 20 ppm and 40 ppm. Sucrose reference compositions were also prepared.
Milk (0% fat)
Milk (0% fat) adjusted to pH 4.6 with lactic acid
Milk (2% fat)
Milk (3.6% fat)
Water
Water, adjusted to pH 4.6 with lactic acid
Water containing c. 120 mg calcium/100 ml (Ca²⁺ added as Gluconal CAL® soluble salt)
Water containing 4.5% lactose
Water containing c. 120 mg calcium/100 mL plus 4.5% lactose
Water containing 3% milk protein isolate (Davisco BiPro)

(iii) Sensory Procedures

Panelists (8-10) were presented with a range (2-12%; w/v) of sucrose reference solutions prepared in each of the mediums listed above as well as two monatin test solutions at 20 ppm and 40 ppm prepared in the same manner. The panelists were instructed to taste the test sample and then to identify the reference sample that matched the perceived sweetness of the test sample. If the sweetness of the test sample was judged to fall between that of two references, panelists were asked to estimate sweetness to one decimal point. Panelists evaluated each sample in duplicate. All results for each test sample were averaged.

TABLE 1
Dose-Response Determinations of R,R Monatin

| | | SEV (%; w/v) | SEV (%; w/v) |
|---|---|---|---|
| Solvent | pH | 20 ppm monatin | 40 ppm monatin |
| Water | 7.8 | 5.1 | 7.7 |
| Water + lactic acid | 4.6 | 6.0 | 7.9 |
| Milk (0% fat) | 6.4 | 5.3 | 8.5 |
| Milk (0% fat; yogurt + milk) | 4.6 | 6.0 | 9.9 |
| Milk (2% fat) | 6.4 | 5.6 | 8.7 |
| Milk (3.6% fat) | 6.4 | 5.2 | 8.3 |
| Water + 120 mg/100 mL | 7.6 | 6.4 | 9.0 |
| calcium^{a} | | | |
| Water + 4.5% lactose | 7.8 | 4.0 | 6.3 |
| Water + calcium + lactose | 7.8 | 5.6 | 8.0 |
| Water + 3% whey protein | 7.8 | 5.2 | 7.6 |
| isolate | | | |

^{a}Gluconal CAL ®. (GC) (Glucona America Inc.,. Janesville, Wis., USA), (a commercial blend of calcium gluconate/calcium lactate)

(iv) Impact of pH

The data indicated that monatin displays a higher relative sweetness at acidic pH compared to that at neutral pH, particularly for milk. For example, the results from Table 1 show that at a monatin level of 20 ppm, the pH adjusted 0% fat milk (pH 4.6) exhibited a 13% sweetness enhancement over the 0% fat milk at pH 6.4. Similarly, at a monatin level of 40 ppm, the milk at pH 4.6 had a 16% sweetness enhancement over the milk at pH 6.4.

(v) Impact of Fat

The monatin solutions prepared in milk provide some indication of the potential impact of fat on perceived sweetness levels. This study illustrated that fat either has no impact on the sweetness of monatin, or that the impact of fat on the sweetness of monatin and sucrose are identical. In short, the relative sweetness values of the monatin solutions prepared from milk were essentially unaffected by the presence of milk fat.

(vi) Impact of Lactose

Lactose appears to exert a significant negative impact on the sweetness of monatin-containing solutions because solutions having monatin with added lactose are less sweet than solutions having monatin alone. For example, the results from Table 1 show that at a monatin level of 20 ppm, the water solution having 4.5% lactose had a 22% decrease in sweetness, as compared to the water solution only containing monatin. At a monatin level of 40 ppm, the lactose containing sampled had an 18% decrease in sweetness.

(vii) Impact of Calcium

Monatin in a water/calcium solution results in a substantially sweeter composition compared to monatin in water alone. The water/calcium solution exhibited a 25% sweetness enhancement over the monatin in water alone at 20 ppm, and a 17% sweetness enhancement at 40 ppm. The sweetness enhancing effect of calcium on monatin-containing compositions is sufficiently large to balance out the possible sweetness suppressing impact of lactose on the relative sweetness of monatin. A blend of monatin/lactose/calcium is essentially as sweet as compositions containing monatin alone, when evaluated in the identical solvents. In fact, the results from Table 1 show that at monatin levels of 20 ppm and 40 ppm, the monatin/lactose/calcium solutions had slightly higher SEV values than the solution only containing monatin.

(viii) Impact of Milk Protein

The addition of milk protein to water had no impact on the sweetness of the solution.

### Example 2

### Concentration-Response Characteristics in Dairy Systems

The present example illustrates the concentration-response characteristics of monatin in acidic and neutral pH conditions for two dairy based systems.

(i) Sensory Procedures

Monatin, aspartame and sucralose samples were prepared in milk (2% fat) and diluted with plain, fat-free yogurt. Sucrose reference solutions were prepared in solutions of the same medium.

Panelists (8-10) were presented with a range (2-12%; w/v) of sucrose reference solutions and a single test sample. They were instructed to taste the test sample and then to identify the reference sample that matched the perceived sweetness of the test sample. If the sweetness of the test sample was judged to fall between that of two references, panelists were asked to estimate sweetness to one decimal point. Panelists evaluated each sample in duplicate. All results for each test sample were averaged.

(ii) Solution Compositions

Sweetener test samples and sucrose references were prepared as solutions in the following mediums:
(1) Milk (2% fat) at pH 6.8.
(2) A diluted plain (unsweetened and unflavored) yogurt was sheared with water (80 parts yogurt and 20 parts water) to yield an acidic solution based on fermented milk with a final pH of 4.6.

TABLE 2
Concentration-Response Determinations of R,R-
Monatin in Milk at Acid and Neutral pH.

| | | SEV | Relative Sweetness |
|---|---|---|---|
| Medium | Monatin (ppm) | (% sucrose; w/v) | (×sucrose) |
| Milk; 2% fat | 5 | 2.0 | 4,000 |
| (pH 6.8) | 10 | 3.0 | 3,000 |
| | 20 | 5.5 | 2,750 |
| | 30 | 6.8 | 2,270 |
| | 40 | 8.4 | 2,100 |
| | 50 | 8.9 | 1,780 |
| Diluted Yogurt | 10 | 4.0 | 4,000 |
| (pH 4.6) | 20 | 6.6 | 3,300 |
| | 30 | 9.3 | 3,100 |
| | 40 | 10.5 | 2,625 |
| | 50 | 11.4 | 2,280 |

As shown in Table 2, the perceived sweetness increased for both the milk and the yogurt as a function of the concentration of monatin. The yogurt samples had a greater sweetness compared to the milk samples. The yogurt samples were fat-free so the higher sweetness levels seen at both pHs is unlikely to be due to the presence of fat, consistent with the analysis above under Example 1. The milk contained more lactose than the yogurt samples (4.8 g/100 g in 2% fat milk as opposed to 3.7 g/100 g for diluted virtually fat free yogurt). As described above under Example 1, lactose appears to counteract the sweetness of monatin. Moreover, the higher relative sweetness of the yogurt compared to the milk is believed to be due, in part, to the more acidic conditions.

Table 1 from Example 1 showed SEV for monatin-containing water solutions at 20 ppm of monatin (SEV equal to 5.1) and at 40 ppm of monatin (SEV equal to 7.7). As shown in Table 2 above, milk containing 20 ppm of monatin had an SEV of 5.5 and milk containing 40 ppm of monatin had an SEV of 8.4. As also shown in Table 2, the yogurt at acidic conditions showed a larger increase in SEV at monatin levels of 20 ppm (SEV equal to 6.6) and 40 ppm (SEV equal to 10.5). The monatin-containing milk solutions and yogurt solutions had higher SEV values than the monatin-containing water solutions, due to the presence of calcium in the milk and yogurt.

### Example 3

### Evaluation of Calcium Salts

The present example evaluated the sweetness of four compositions, with each composition containing a different calcium salt in combination with monatin. The four compositions were compared to a control sample only containing monatin.

(i) General Procedure

Test and reference solutions were prepared in the same medium. The SEVs of monatin/salt combinations at the appropriate concentrations were measured and compared to the SEV of monatin measured in the absence of any salts. For each of the salts, 1200 ppm of calcium was used.

Monatin-containing test samples and sucrose references were prepared in the same medium. Based on the previous observations that the sweetness of monatin relative to sucrose is sweeter at acidic pH, this study was carried out under two pH conditions; specifically, in water at pH 7-7.5 and in a citric/citrate buffer at pH 3.0.

2R,4R-Monatin mono potassium salt was used as an illustrative form of monatin for the experiments below. All monatin solutions were prepared ‘as is’, i.e., a 40 ppm monatin solution is 40 ppm of monatin mono potassium salt.

A sweetness matching procedure was adopted. Panelists (8-10) were presented with a range (7-12%; w/v, in steps of 0.5%; w/v sucrose) of sucrose reference solutions and a single test sample. Each test sample was either monatin control or monatin plus designated salt at the stated concentration. Panelists were instructed to taste the test sample and then to identify the reference sample that matched the perceived sweetness of the test sample. If the sweetness of the test sample was judged to fall between that of two references, panelists were instructed to estimate sweetness to one decimal point.

Panelists evaluated each sample in duplicate. Results for each test sample were averaged. This procedure was also followed for the experiments disclosed in Example 4 (samples in Table 4 only) and Example 5 below.

(ii) Results

The results generated are presented in Table 3, which shows the sucrose equivalency value and sweetness enhancement for the four calcium salts used in combination with 40 ppm of monatin, as compared to a sample of 40 ppm of monatin only. The five samples were tested at pH 7 (water medium) and at pH 3 (citric/citrate buffer). In each of the samples having calcium salt, the concentration of calcium was 1200 ppm. The weight percent of calcium in the salt is different for each of the calcium salts. As such, the weight percent of the calcium salt in each sample is calculated in order to determine how much salt is needed to deliver 1200 ppm of calcium cations. For example, calcium chloride has a molar mass of 111.0 g/mol. Calcium is approximately 36% of the molar mass of calcium chloride (i.e. 40 g/mol of 111 g/mol total). In order to have 1200 ppm of calcium in the sample (0.12%), the weight percent of calcium chloride is 0.33% (i.e. 0.12 wt % divided by 36 wt %). Thus, 0.33 grams of calcium chloride are added per 100 grams of water or citrate buffer. The weight percent of the other calcium salts is similarly calculated based on the molar weight percent of calcium in the calcium salt.

TABLE 3
Evaluation of Various Calcium Salts
at 1200 ppm Ca²⁺ on 40 ppm Monatin

| | | Sucrose Equivalency | Sweetness |
|---|---|---|---|
| pH | Salt | Value (%) | Enhancement (%) |
| 3.0 | None* | 8.6 | — |
| | Calcium lactate | 9.5 | 10 |
| | Calcium gluconate | 9.2 | 7 |
| | Gluconal CAL ® | 9.0 | 5 |
| | Calcium chloride | 10.3 | 20 |
| 7.0 | None* | 8.4 | — |
| | Calcium lactate | 9.5 | 13 |
| | Calcium gluconate | 9.5 | 13 |
| | Gluconal CAL | 9.1 | 8 |
| | Calcium chloride | 10.1 | 20 |

*Monatin only (40 ppm)

The results of Table 3 illustrate that, in general, all of the calcium salt samples had an increased sweetness compared to the samples of monatin alone. At both pH levels, the calcium chloride samples showed the highest sucrose equivalency value (SEV), and thus the highest sweetness enhancement percent.

While not wishing to be bound by theory, it is believed that the ability of the calcium to enhance the sweetness of the monatin in the calcium-monatin-containing compositions is dependent on the calcium salt being soluble and thus able to dissolve in the composition. Based on the solubility of each of the calcium salts in Table 3, all of the salts should have been soluble at the concentrations used in this example.

Samples with calcium lactate and samples with calcium gluconate, although showing significant sweetness enhancement at both pH 3 and pH 7, had lower sweetness enhancement percentages, compared to samples with calcium chloride. As stated above, both of these salts were soluble at the concentrations used in this example. Thus, other properties of the calcium salts, in addition to solubility, may influence the sweetness enhancement for a particular calcium salt. While not wanting to be bound by theory, it is believed that the anion (conjugate base) may influence calcium's enhancement of the sweetness of the monatin-containing composition. Because lactate ions and gluconate ions are stronger conjugate bases, as compared to chloride ions, lactate and gluconate have a greater affinity for calcium (i.e. a greater association constant) than chloride does, and the calcium cations from calcium lactate and calcium gluconate salts may be less “available” to interact with monatin. Thus, the level of dissociation between calcium and its corresponding anion may influence the sweetness enhancement of the monatin-containing composition for that particular calcium salt.

### Example 4

### Effect of Calcium Concentration on Sweetness

As shown above in Table 3, calcium chloride exhibited the highest sweetness enhancement, as compared to the other calcium salts. In the present example, samples were prepared having 40 ppm of monatin and calcium (from calcium chloride) at 200, 400, 800, 1200 and 1600 ppm, as compared to a control sample having 40 ppm of monatin without calcium. The samples were created at pH 3 and pH 7. The results are shown in Table 4.

TABLE 4
Concentration-Response Effects of Calcium as Calcium Chloride

| | Salt Concentration | Sucrose Equivalency | Sweetness |
|---|---|---|---|
| pH | (ppm) | Value (%) | Enhancement (%) |
| 3.0 | 0* | 8.6 | — |
| | 200 | 9.5 | 10 |
| | 400 | 10.0 | 16 |
| | 800 | 10.2 | 19 |
| | 1200 | 10.3 | 20 |
| | 1600 | 10.2** | 19 |
| 7.0 | 0* | 8.4 | — |
| | 200 | 10.0 | 19 |
| | 400 | 10.2 | 21 |
| | 800 | 10.2 | 21 |
| | 1200 | 10.1 | 20 |
| | 1600 | 10.2** | 21 |

*Monatin only (40 ppm)
**Solutions were perceived as being very salty, so estimates of SEV were described as being very difficult to perform.

The concentration-response study of calcium chloride demonstrated that the concentration of calcium required for the enhancing effect to be maximized is substantially lower than occurs in milk. As little as 200 ppm of calcium from calcium chloride was sufficient for the sweetness enhancement effect to be observed.

The results in Table 4 above show that, even at low concentrations of calcium, there is an enhanced sweetness of monatin-containing solutions. For example, at 200 ppm of calcium, sweetness enhancement levels were 10% and 19% at pH 3 and pH 7, respectively. Further experiments were conducted to determine if calcium enhances or increases the perceived sweetness of monatin-containing solutions at levels below 200 ppm of calcium, and the results are shown in Table 5 below.

The samples in Table 5 were prepared by adding 20 ppm of monatin to water in combination with an amount of calcium ranging between 12.5 ppm and 200 ppm. A control sample having 20 ppm of monatin and no calcium was also used. The monatin was in the R,R, form and prepared through a biosynthetic pathway as disclosed in U.S. Patent Publication No. 2005/282260. A three-member panel was used to evaluate sweetness, but instead of quantifying the sample in terms of sweetness equivalency (SEV), the panelists assigned the sample a number between 0 and 9 (see description of scale under Table 5).

TABLE 5
Sweetness of R,R-Monatin Solution at Calcium levels ≦200 ppm

| Calcium Concentration (ppm) | *Difference in Sweetness Due to Calcium |
|---|---|
| 0 | N/A |
| 12.5 | 1 |
| 25 | 3 |
| 50 | 4 |
| 100 | 5 |
| 200 | 6 |

*0 = none, 1 = trace, 2 = faint, 3 = slight, 4 = mild, 5 = moderate, 6 = definite, 7 = strong, 8 = very strong, 9 = extreme

At 12.5 ppm of calcium, two of the three panelists assigned the sweetness a 1 on the scale. At calcium levels of 25 ppm and greater, there was consensus among the three panelists in terms of the sweetness scale rating.

The results in Table 5 illustrate that at only 25 ppm of calcium, all of the panelists noticed a slight difference in sweetness as a result of the calcium. The difference in sweetness became more apparent as a function of an increase in the concentration of calcium. The results from Table 5 also illustrate that the difference in sweetness did not plateau within the concentration range tested (i.e. up to 200 ppm). This is consistent with the results shown in Table 4, which show a larger sweetness enhancement at 400 ppm, as compared to 200 ppm, particularly at pH 3. The results from Table 5 are favorable in that a smaller amount of calcium may be used in combination with monatin, and an enhanced sweetness is still observed.

### Example 5

### Evaluation of Enhancement Effects of Other Salts

The impact of other metal ions, specifically potassium and magnesium, (i.e. K⁺ and Mg²⁺) were also assessed and the results are shown in Table 6. These ions were tested in the form and concentrations found in cow's milk.

TABLE 6
Enhancement Effects of Potassium and Magnesium

| | Salt/Concentration | Sucrose Equivalency | Sweetness |
|---|---|---|---|
| pH | (ppm) | Value (%) | Enhancement (%) |
| 3.0 | None* | 8.6 | — |
| | Potassium chloride** | 9.2 | 7 |
| | 1450 ppm K⁺ | | |
| | Magnesium gluconate | 9.1 | 6 |
| | 170 ppm Mg²⁺ | | |
| 7.0 | None* | 8.4 | — |
| | Potassium chloride** | 8.7 | 4 |
| | 1450 ppm K⁺ | | |
| | Magnesium gluconate | 9.2 | 9 |
| | 170 ppm Mg++ | | |

*Monatin only (40 ppm)
**Solutions were perceived as being very salty, so estimates of SEV were described as being very difficult to perform.

Although small levels of apparent sweetness enhancement were reported for potassium and magnesium, the enhancement was less than when calcium is used with monatin. Moreover, at the tested concentration of 1450 ppm, the samples with potassium chloride (KCl) exhibited a clear salt taste, thus complicating the assessment procedure.

### Example 6

### Instant Tea Beverage

In this example, monatin was added to an instant tea beverage. The monatin was 2R,4R monatin monopotassium salt prepared by a biosynthetic pathway, which was also used in Example 7. The formulation for the instant tea beverage is shown in the table immediately below.

TABLE 7
Ingredients in Instant Tea Beverage.

| Ingredients | Weight (g) | % Formula |
|---|---|---|
| Water | 4181.5 | 99.56 |
| Instant Tea (Unsweetened) | 16.4 | 0.39 |
| Tea Flavor | 2.1 | 0.05 |
| R,R-Monatin | 0.063-0.084 | 0.0015-0.0020 |
| Total | 4200.0 | 100.0 |

Three sets of samples were prepared and are shown in Table 8. In one set of samples (sample 2), calcium was added in the form of calcium chloride. Nine trained panelists tested each of the three samples with three replications for each sample. Therefore the SEV data is based on 27 measurements. The monatin used in the present example was from the same lot as that used in the samples shown in Table 5 above under Example 4 and in Table 10 below under Example 7.

TABLE 8
Evaluation of sweetness for samples of instant tea beverage.

| | | | Sucrose | Sweetness |
|---|---|---|---|---|
| | Amount of | Amount of | Equivalency | Enhancement |
| Sample | Monatin (ppm) | Calcium (ppm) | Value (%) | (%) |
| 1 | 15 | 0 | 4.0 | — |
| 2 | 15 | 400 | 5.2 | 30 |
| 3 | 20 | 0 | 5.2 | — |

The results from Table 8 illustrate that the addition of calcium (400 ppm) to the instant tea beverage in sample 2 resulted in a 30% sweetness enhancement as compared to sample 1 containing monatin without calcium. The results from samples 2 and 3 show that even though there was a 25% reduction in monatin in sample 2 compared to sample 3, the sweetness of example 2 was about equal to the sweetness of sample 3, given the addition of calcium in sample 2.

### Example 7

### Berry Flavored Beverage

In this example, 40 ppm of monatin was added to a berry flavored beverage having the following formulation.

TABLE 9
Ingredients in Mixed Berry Beverage.

| Ingredients | Weight (g) | % Formula |
|---|---|---|
| Water | 2292.4 | 99.66 |
| Maleic Acid | 2.3 | 0.10 |
| Trisodium Citrate | 3.2 | 0.14 |
| Mixed Berry Flavor | 2.3 | 0.10 |
| R,R-Monatin | 0.0920 | 0.004 |
| Total | 2300.2 | 100.0 |

Two sets of samples were prepared with monatin—one set without any calcium, the second set having 400 ppm of calcium. Six trained panelists tested each of the samples with 3 replications (18 measurements total).

TABLE 10
Evaluation of sweetness for samples of berry flavored beverage.

| | | | Sucrose | Sweetness |
|---|---|---|---|---|
| | Amount of | Amount of | Equivalency | Enhancement |
| Sample | Monatin (ppm) | Calcium (ppm) | Value (%) | (%) |
| 1 | 40 | 0 | 7.7 | — |
| 2 | 40 | 400 | 8.4 | 9 |

The samples containing a combination of monatin and calcium exhibited a higher sweetness level than those only containing monatin. Although the increase in sweetness of the calcium-monatin samples for the berry flavored beverage were not as significant as compared to the instant tea samples in Example 6 above, a 9% sweetness enhancement was still observed.

### Example 8

### Strawberry Yogurt

A strawberry yogurt sweetened with about 8% sucrose was prepared by conventional methods common to one skilled in the art of yogurt manufacturing to serve as a sweetness target. A set of five (5) yogurt samples were sweetened with R,R-monatin monopotassium salt using the ingredients listed in Table 11. Each of the five samples had a particular amount of R,R monatin (i.e. about 15 ppm, about 20 ppm, about 25 ppm, about 30 ppm and about 35 ppm.) Each of the five samples of monatin-sweetened yogurt were compared to the target sample containing 8% sucrose. The monatin-sweetened yogurt that most closely matched the sweetness of the target sucrose sample was chosen.

TABLE 11
Ingredients in Strawberry Yogurt

| Ingredients | Weight (g) | % Formula |
|---|---|---|
| Skim Milk | 996.0 | 79.8% |
| Cream, 36% Fat | 33.6 | 2.7% |
| Dried Skim Milk Powder | 44.4 | 3.6% |
| Corn Starch, Modified | 18.0 | 1.4% |
| Gelatin | 6.0 | 0.5% |
| R,R-Monatin | 0.0312 | 0.0025% |
| Strawberry Fruit & Flavoring | 149.7 | 12.0% |
| Total | 1247.7 | 100.0 |

The monatin concentration that most closely matched the sweetness of yogurt sweetened to 8% sucrose was about 25 ppm R,R-monatin monopotassium salt. (In other words, the monatin-sweetened yogurt with 25 ppm R,R monatin had an SEV of about 8%.) Thus, the formulation having 25 ppm R,R-monatin is the formulation shown in Table 11 above. In this example, monatin was about 3200 times as sweet as sucrose.

### Example 9

### Chocolate Milk

A chocolate milk composition sweetened with 42 DE high fructose corn syrup (HFCS) to about 10% sucrose was prepared by conventional methods common to one skilled in the art of flavored milk manufacturing to serve as a sweetness target. Then a set of five (5) milk samples were sweetened with R,R-monatin monopotassium salt using the ingredients listed in Table 12. The amount of monatin in the five samples was about 25 ppm, about 30 ppm, about 35 ppm, about 40 ppm and about 45 ppm. Each of the five samples of monatin-sweetened milk were compared to the target milk sample containing 10% sucrose. The monatin-sweetened milk that most closely matched the sweetness of the target sucrose sample was chosen.

TABLE 12
Ingredients in Chocolate Milk

| Ingredients | Weight (g) | % Formula |
|---|---|---|
| Milk, 1% Fat | 7847.7 | 98.1% |
| Cocoa Powder, Russet Plus | 80.0 | 1.0% |
| Vitex XN ABN 340 | 56.0 | 0.7% |
| Guar Gum | 8.0 | 0.1% |
| Chocolate Flavor | 4.0 | 0.05% |
| R,R-Monatin | 0.2800 | 0.0035% |
| Salt | 4.0 | 0.05% |
| Total | 8000.0 | 100.0 |

The monatin concentration that most closely matched the sweetness of milk sweetened to 10% sucrose was about 35 ppm R,R-monatin monopotassium salt, and this formulation is shown in Table 12 above. Monatin was about 2800 times as sweet as sucrose in this example.

### Example 10

### Vanilla Ice Cream

A vanilla ice cream sweetened with about 13% sucrose was prepared by conventional methods common to one skilled in the art of ice cream manufacturing to serve as a sweetness target. Then a set of seven (7) ice cream samples were sweetened with R,R-monatin monopotassium salt using the ingredients listed in Table 13. The amount of monatin in the seven samples was about 35 ppm, about 40 ppm, about 45 ppm, about 50 ppm, about 55 ppm, about 60 ppm and about 70 ppm. Each of the seven samples of monatin-sweetened ice cream were compared to the target ice cream sample containing 13% sucrose. The monatin-sweetened ice cream that most closely matched the sweetness of the target sucrose sample was chosen.

TABLE 13
Ingredients in Vanilla Ice Cream

| Ingredients | Weight (g) | % Formula |
|---|---|---|
| Whole Milk | 176.9 | 69.3% |
| Dried Skim Milk Powder | 9.4 | 3.7% |
| Cream, 36% Fat | 15.0 | 5.9% |
| Maltodextrin, 18DE | 22.5 | 8.8% |
| Erythritol | 6.3 | 2.4% |
| R,R-Monatin | 0.0115 | 0.0045% |
| Polydextrose | 12.5 | 4.9% |
| Gelatin, 240 Bloom | 3.8 | 1.5% |
| Vanilla Extract | 8.9 | 3.5% |
| Total | 251.5 | 100.0 |

The monatin concentration that most closely matched the sweetness of ice cream sweetened to 13% sucrose was about 45 ppm R,R-monatin monopotassium salt and that particular formulation is shown in Table 13 above. So monatin was about 2800 times as sweet as sucrose in this example.

### Example 11

### Packet Formulations Comprising Monatin and Calcium

The present example discloses formulations for a packet sweetener having monatin (Sample 11A) and a packet sweetener having monatin and calcium in combination (Sample 11B). The packet formulations for Samples 11A and 11B are shown in Table 14 below. Each packet weighs about 1 gram.

TABLE 14
Packet Formulations for Samples 11A and 11B

| Ingredient (mg) | 11A | 11B |
|---|---|---|
| Dextrose | 500 | 457.3 |
| Maltodextrin | 496 | 452 |
| R,R-Monatin | 4.0 | 3.15 |
| Calcium Chloride | 0 | 87.57 |
| Total Wt (mg) | 1000 | 1000 |

Samples 11A and 11B are prepared to deliver the sweetness of about two teaspoons of sugar (about eight grams). As shown in Table 14, the addition of calcium chloride in Sample 11B results in a reduction from 4.0 mg of R,R monatin to 3.15 mg of R,R monatin. In other words, about 21% less monatin is used in Sample 11B compared to Sample 11A, and due to the addition of calcium chloride, equivalent sweetness is achieved. Sample 11A contains 4000 ppm of R,R monatin and Sample 11B contains 3150 ppm of R,R monatin. Sample 11B contains 8.76 wt % calcium chloride and 3.15 wt % calcium cations.

### Example 12

### Ready to Use Formulations Comprising Monatin and Calcium

The present example discloses formulations in Table 15 below for a ready to use sweetener having monatin (Sample 12A) and a ready to use sweetener having monatin and calcium in combination (Sample 12B). Each sample is about 1 gram.

TABLE 15
Ready to Use Formulations for Samples 12A and 12B

| Ingredient (mg) | 12A | 12B |
|---|---|---|
| Maltodextrin | 999.5 | 988.48 |
| R,R-Monatin | 0.5 | 0.4 |
| Calcium Chloride | 0 | 11.12 |
| Total Wt (mg) | 1000 | 1000 |

The ready to use sweeteners in Table 15 are prepared as “spoon for spoon” formulations to be used in place of granulated sugar. Since the ready to use sweeteners are formulated to have the same sweetness as an equivalent volume of sugar, the ready to use sweeteners may be added straight to beverages or food as an equal substitute for granulated sugar.

As shown in Table 15, the use of calcium chloride in combination with monatin in Sample 12B results in a 20% reduction of monatin compared to Sample 12A to achieve an equivalent sweetness. Sample 12A contains 500 ppm of R,R monatin and sample 12B contains 400 ppm of R,R monatin. Sample 12B contains 1.11 wt % calcium chloride and 0.4 wt % calcium cations.

A number of embodiments have been described. Nevertheless, it will be understood that various modifications may be made without departing from the spirit and scope of the disclosure. It is to be understood that while the invention has been described in conjunction with the detailed description thereof, the foregoing description is intended to illustrate and not limit the scope of the invention. Accordingly, other embodiments are within the scope of the following claims.

1. A non-dairy food product comprising:
monatin or a salt thereof; and
calcium, wherein the food product has a sweetness greater than a sweetness of a comparable food product comprising monatin without calcium.

2. The non-dairy food product of claim 1 wherein the calcium is a calcium salt.

3. The non-dairy food product of claim 2 wherein the calcium salt is selected from the group consisting of calcium lactate, calcium gluconate, calcium chloride, and combinations thereof.

4. The non-dairy food product of claim 1 wherein the food product is a reduced-sugar food product and an amount of monatin in the food product is between about 5 and about 50 ppm of the food product.

5. The non-dairy food product of claim 1 wherein an amount of monatin in the food product is between about 20 and about 50 ppm of the food product.

6. The non-dairy food product of claim 1 wherein the monatin is stereoisomerically-enriched R,R monatin or a salt thereof.

7. The non-dairy food product of claim 1 wherein an amount of calcium in the food product is at least about 25 ppm of the food product.

8. The non-dairy food product of claim 1 wherein an amount of calcium in the food product is at least about 200 ppm of the food product.

9. The non-dairy food product of claim 1 wherein the food product is a beverage.

10.-22. (canceled)

23. A sweetening composition for use in a food product, the composition comprising monatin or a salt thereof and calcium, wherein the food product has a perceived sweetness that is greater than a perceived sweetness of a comparable food product having a sweetening composition containing a comparable amount of monatin without calcium.

24. (canceled)

25. The sweetening composition of claim 23 wherein the perceived sweetness of the food product containing the sweetening composition is at least 10 percent greater than the perceived sweetness of the comparable food product.

26. The sweetening composition of claim 25 wherein the perceived sweetness of the food product is at least 20 percent greater than the perceived sweetness of the comparable food product.

27. The sweetening composition of claim 23 wherein the calcium is a calcium salt.

28. The sweetening composition of claim 27 wherein the calcium salt is selected from the group consisting of calcium lactate, calcium gluconate, calcium chloride, and combinations thereof.

29. The sweetening composition of claim 23 wherein a volume of the sweetening composition provides a sweetness comparable to an equal volume of granulated sugar.

30.-32. (canceled)

33. A method of sweetening a non-dairy food product, the method comprising:
adding monatin or a salt thereof to the food product; and
adding calcium to the food product, wherein the food product has a perceived sweetness that is greater than a perceived sweetness of a comparable food product containing monatin without calcium.

34. The method of claim 33 wherein the non-dairy food product is a beverage.

35. The method of claim 33 wherein the food product is a reduced-sugar product and about 5 to about 50 ppm of monatin is added to the food product.

36. (canceled)

37. The method of claim 33 wherein at least about 25 ppm of calcium is added to the food product.

38. The method of claim 33 wherein at least about 200 ppm of calcium is added to the food product
